(19) United States
(12) Patent Application Publication
(10) Pub. No.: US 2025/0338149 A1
(43) Pub. Date: Oct. 30, 2025

(54) SYSTEMS AND METHODS FOR IMPROVING WIRELESS CELLULAR NETWORK ROBUSTNESS DURING DISASTERS

(71) Applicant: AT&T Intellectual Property I, L.P., Atlanta, GA (US)

(72) Inventors: Amit Kumar Sheoran, Raritan, NJ (US); Vijay Gopalakrishnan, Edison, NJ (US)

(73) Assignee: AT&T Intellectual Property I, L.P., Atlanta, GA (US)

(21) Appl. No.: 18/650,328

(22) Filed: Apr. 30, 2024

(51) Int. Cl. H04W 24/04; H04W 76/19

(52) U.S. Cl. CPC H04W 24/04; H04W 76/19

(57) ABSTRACT

Aspects of the subject disclosure may include, for example, radio access nodes (RANs) instantiating network slices when backhaul connections are severed. The network slices may include functionality that allows user equipments (UEs) attached to the RAN nodes to communicate with each other. RAN nodes may query other RAN nodes and UEs to determine if an alternate backhaul is available. Other embodiments are disclosed.

### FIELD OF THE DISCLOSURE

The subject disclosure relates to providing cellular communications during outages.

### BACKGROUND

In cellular networks deployed today, radio access network (RAN) nodes (e.g., eNodeB, gNodeB, etc.) are typically unable to operate independently in case their connection to the backhaul is severed. A severed connection to a backhaul may have many different causes, including a natural disaster, a fiber severed by a trencher, a power outage, or the like. Depending on the nature of the severed connection, a RAN node may lose all wired and/or wireless connectivity or may lose partial wired and/or wireless connectivity.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of RAN nodes communicating with UEs in accordance with various aspects described herein.

FIG. 2C is a block diagram illustrating an example, non-limiting embodiment of RAN nodes communicating with each other and communicating with UEs in accordance with various aspects described herein.

FIGS. 2D-2F are block diagrams illustrating example, non-limiting embodiments of RAN nodes making use of connection(s) to alternate backhaul(s) in accordance with various aspects described herein.

FIG. 2G depicts illustrative embodiments of methods in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for providing communications when a connection to a backhaul is lost. Other embodiments are described in the subject disclosure.

One or more aspects of the subject disclosure include a device, having a processing system including a processor; and a memory that stores executable instructions that, when executed by the processing system, facilitate performance of operations. The operations may include determining that a first radio access network (RAN) node has lost connection to a first backhaul; instantiating a network slice at the first RAN node to provide communication between user equipments (UEs) connected to the first RAN node.

One or more aspects of the subject disclosure include a non-transitory machine-readable medium, comprising executable instructions that, when executed by a processing system including a processor, facilitate performance of operations. The operations may include determining that a first RAN node has lost a connection to a first backhaul; communicating, by the first RAN node, with other RAN nodes to find a connection to a second backhaul; responsive to the communicating, determining that a second RAN node has the connection to the second backhaul; and providing a communication path for at least one user equipment (UE) attached to the first RAN node to the second RAN node for use of the connection to the second backhaul.

One or more aspects of the subject disclosure include one or more methods. The method(s) may include collecting, at a first radio access network (RAN) node, by a processing system including a processor, information regarding a plurality of UEs connected to the first RAN node; instantiating, by the processing system, in response to the first RAN node losing a connection to a communication network core, a disaster slice at the first RAN node, wherein the disaster slice provides communications among the plurality of UEs connected to the first RAN node using the information regarding the plurality of UEs connected to the first RAN node; and communicating, by the processing system, with other wireless devices to determine if a connection to an alternate backhaul is available.

Additional aspects of the subject disclosure may include wherein the determining that the first RAN node has lost connection to the first backhaul comprises determining that the first RAN node has lost connection to a core network; wherein the instantiating the network slice comprises determining that the first RAN node maintains sufficient information regarding the UEs to provide the communication between the UEs; and/or wherein the instantiating the network slice comprises determining that the first RAN node lacks sufficient information regarding the UEs to provide the communication between the UEs, detaching the UEs from the first RAN node, reattaching the UEs to the first RAN node, and collecting the sufficient information regarding the UEs to provide the communication between the UEs; and wherein the reattaching the UEs to the first RAN node comprises reattaching the UEs without encryption. Further additional aspects may include a UE reattaching to a different RAN node. The RAN nodes (e.g., the RAN node from which the UE detached, and the RAN node to which the UE attaches) may transfer the information needed among themselves to continue user connection.

Further additional aspects of the subject disclosure may include the first RAN node communicating with a second RAN node, sharing information regarding the UEs with the second RAN node, and providing communication between at least one of the UEs connected to the first RAN node and at least one other UE connected to the second RAN node; wherein the first RAN node communicates with the second RAN node over a network interface to provide the communication between the at least one of the UEs connected to the first RAN node and the at least one other UE connected to the second RAN node; wherein the first RAN node communicates with the second RAN node through a wireless device connected to both the first RAN node and the second RAN node using cellular dual connectivity; determining that a first UE of the UEs has a multi radio access technology (RAT) capability; and/or determining that the multi-RAT capability supports a connection to a second backhaul, and using the connection to the second backhaul to provide communications abilities to ones of the UEs other than the first UE.

Further additional aspects of the subject disclosure may include the first RAN node communicating with a second RAN node to determine if the second RAN node has a connection to a second backhaul, and providing a communication path between at least one of the UEs and the connection to the second backhaul over a network interface between the first RAN node and the second RAN node; and/or wherein the second backhaul comprises a satellite connection at the second RAN node.

Further additional aspects of the subject disclosure may include wherein the providing the communication path comprises communicating, by the first RAN node, with the second RAN node over a network interface between the first RAN node and the second RAN node, and/or wherein the providing the communication path comprises communicating, by the first RAN node, with the second RAN node through a device connected to both the first RAN node and the second RAN node using cellular dual connectivity.

Further additional aspects of the subject disclosure may include wherein the communicating with other wireless devices comprises communicating with the plurality of UEs to determine if any of the plurality are multi radio access technology (RAT) devices capable of providing the connection to the alternate backhaul, wherein the communicating with other wireless devices comprises communicating with RAN nodes other than the first RAN node, wherein the communicating other RAN nodes comprises communicating over a network interface, wherein the instantiating the disaster slice comprises instantiating a subset of core network functions at the first RAN node; and/or sharing, by the processing system, the information regarding the plurality of UEs with a second RAN node to provide communications between one of the plurality of UEs attached to the first RAN node and at least one UE attached to the second RAN node, wherein the communications between the one of the plurality of UEs attached to the first RAN node and at least one UE attached to the second RAN node uses a network interface between the first RAN node and the second RAN node.

Various embodiments described herein create an on-demand fully autonomous RAN slice that is capable of routing calls to users that are connected to the same RAN node (e.g., eNodeB, gNodeB, etc.) or to users that are in a given geographical region during loss of a backhaul connection. In some embodiments, user connectivity is improved during disasters. In some embodiments, devices that are connected to same RAN node are allowed to send/receive text messages or make voice calls to each other via the RAN node. Further, in some embodiments, devices that are connected to adjacent RAN nodes that are connected via point-to-point links or network interfaces (e.g., Xn interface, X2 interface) are allowed to send/receive text messages or make voice calls to each other via the RAN node. Further, in some embodiments, RAN nodes discover devices with multi-RAT access and use their uplink to route data of users with LTE only access. Further, in some embodiments, RAN nodes discover other RAN nodes with satellite backhaul and use their backhaul to route messages and download authentication information. Further, in some embodiments, RAN nodes discover UEs that have connectivity to other RAN nodes with alternate active backhauls and use these UEs to uplink data to the RAN nodes with alternate active backhauls.

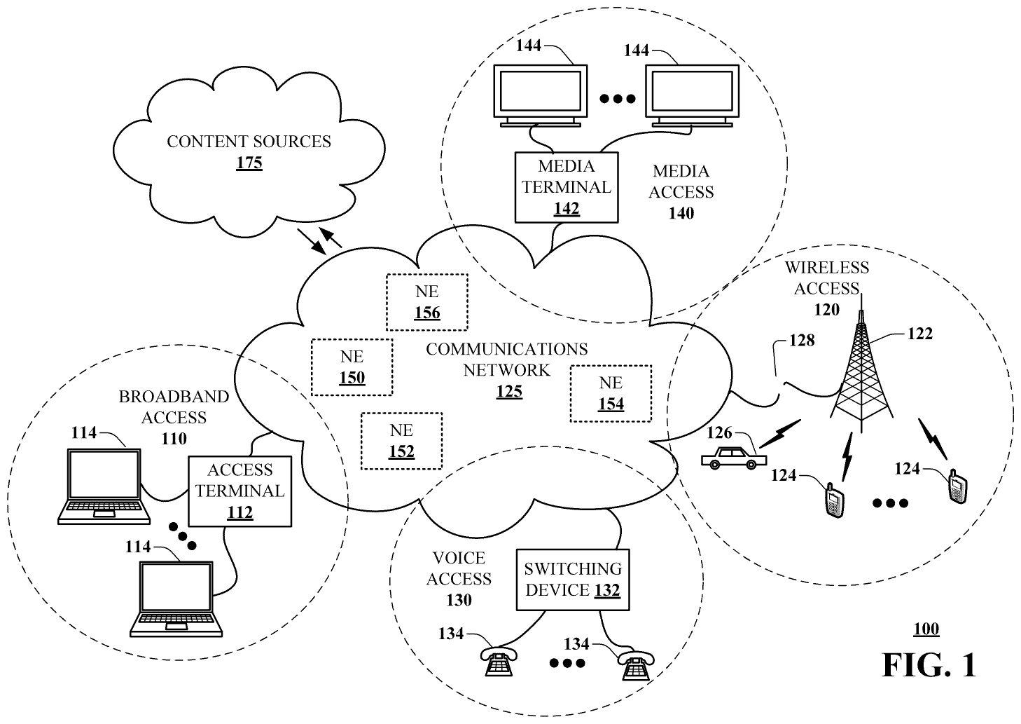

Referring now to FIG. 1, a block diagram is shown illustrating an example, non-limiting embodiment of a system 100 in accordance with various aspects described herein. For example, system 100 can facilitate in whole or in part increasing user connectivity during the loss of a backhaul connection. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

In various embodiments, the RAN node (e.g., base station, eNodeB, gNodeB) 122 can include a 4G, 5G, or higher generation RAN node. The user equipments (UEs) 124 and 126 can include vehicles, mobile phones, e-readers, tablets, phablets, wireless modems, and/or other (mobile or immobile) computing devices. RAN node 122 is shown having a severed backhaul connection 128. In some embodiments, the severed backhaul connection 128 is between RAN node 122 and communications network 125 as shown in FIG. 1. Also in some embodiments, the severed backhaul connection is located within communications network 125, such that one or more network elements within communications network 125 are still reachable by RAN node 122.

The severed backhaul connection may be caused in any manner. For example, a fiber may be cut resulting in a single RAN node having power but no other connectivity or resulting in a set of RAN nodes being isolated as a group but having no other connectivity. In some embodiments, a natural disaster or a power outage may result in a severed backhaul. For example, one or more servers or network elements within communications network 125 may lose power, resulting in a single RAN node or a group of RAN nodes losing a connection to their backhaul network. In some embodiments, the loss of the backhaul may be a result of a loss of control plane communications, a loss of data plane communications, or a combination of the two.

Various embodiments described herein create an on-demand fully autonomous RAN slice within RAN node 122 (and optionally in other RAN nodes as well) or near RAN node 122 (e.g., at an edge of communications network 125) that is capable of routing calls between UEs 124, 126 during loss of a backhaul connection. For example, during loss of a backhaul connection, UEs 124, 126 may be able to send/receive text messages or make voice calls to each other via the RAN node 122. Further, in some embodiments, UEs that are connected to adjacent RAN nodes (not shown in FIG. 1) that are connected via point-to-point links or network interfaces (e.g., Xn interface, X2 interface) may be able to send/receive text messages or make voice calls to each other via the RAN nodes interconnected by point-to-point links or network interfaces. Further, in some embodiments, RAN node 122 may discover a device (e.g., one of UEs 124) with multi-RAT access and use that device's uplink to route data of other UEs 124, 126 attached to RAN node 122 or other RAN nodes in communication with RAN node 122. Further, in some embodiments, RAN node 122 may discover other RAN nodes with satellite backhaul and use the other RAN nodes' satellite backhaul to route messages and download authentication information. Further, in some embodiments, RAN node 122 may discover UEs that have connectivity to other RAN nodes with alternate active backhauls and use these UEs to uplink data to the RAN nodes with alternate active backhauls. These and other embodiments are further described below.

Many scenarios and/or criteria, when satisfied, may trigger a RAN node to switch to disaster mode and instantiate a disaster slice. For example, a complete outage may trigger a RAN node to switch to disaster mode and instantiate a disaster slice. A RAN node may detect a complete outage when the RAN node has lost connectivity to the core network. Also for example, a partial outage may trigger a RAN node to switch to disaster mode and instantiate a disaster slice. A RAN node may detect a partial outage when a significant number of messages (e.g., a number above a threshold) sent by the RAN node to the core network are failing or are timing out. In some embodiments, during a partial outage, messages for a given subset of the users might be failing (depending upon which core network instance hosts user data), and it is possible that users connected to the same RAN node are being handled by different core network server instances. RAN nodes may detect which set of users are experiencing failures and selectively move these users to the disaster slice. Further, once a partial outage is identified, a RAN node may use any of the mechanisms (e.g., methods and apparatus) described herein to enable connectivity for the subset of users that are experiencing failures/partial outages.

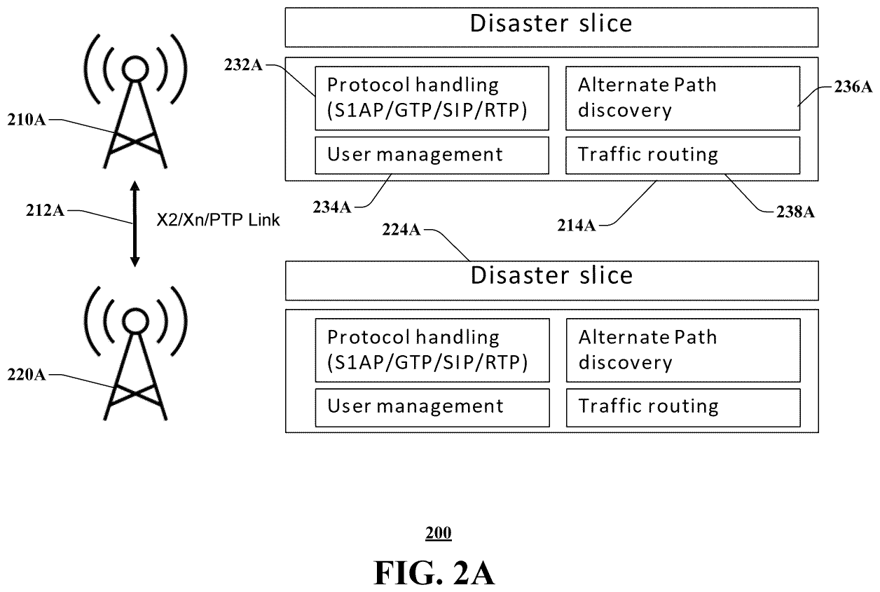

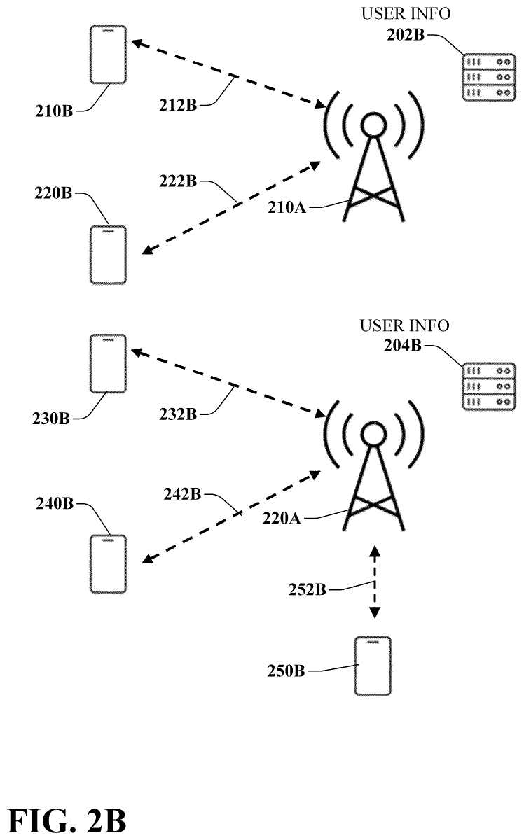

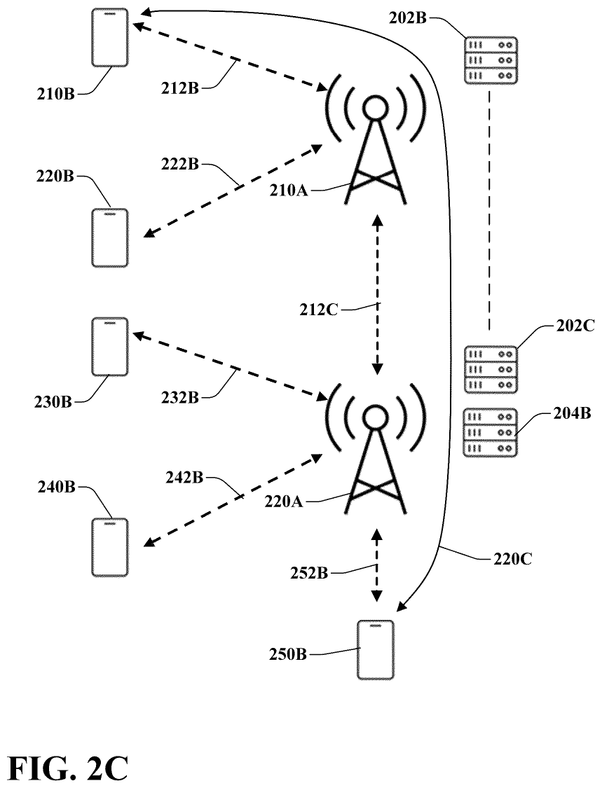

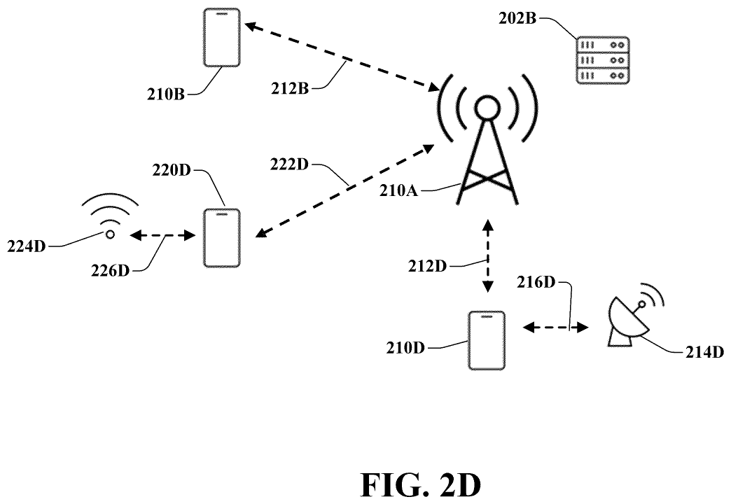

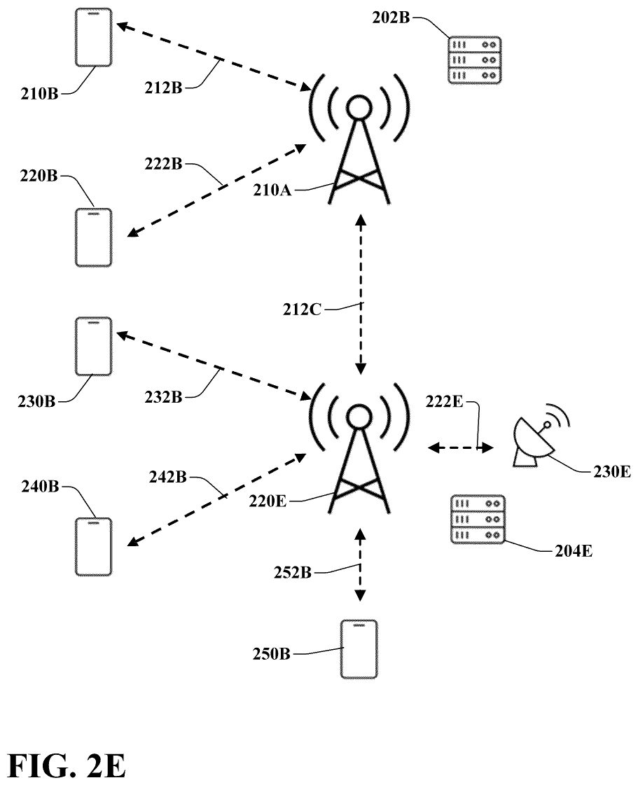

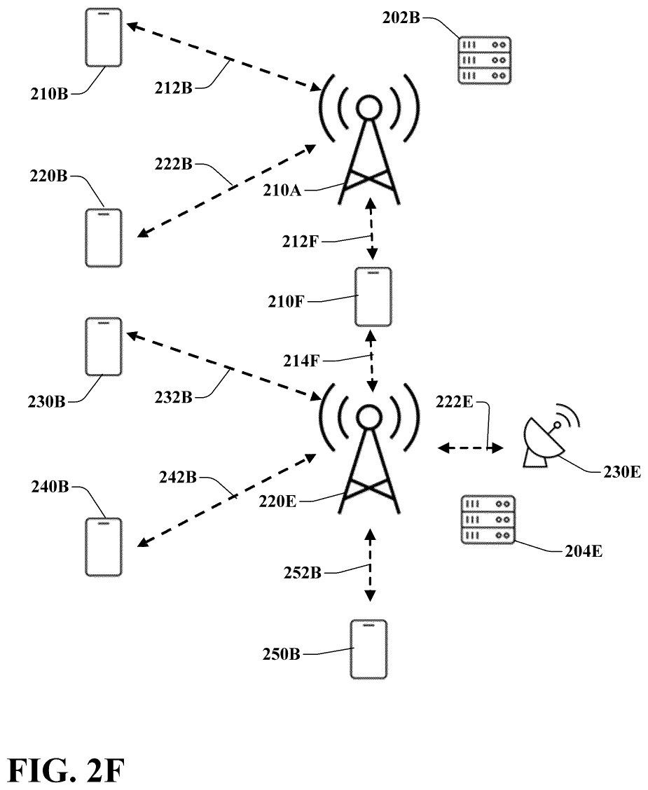

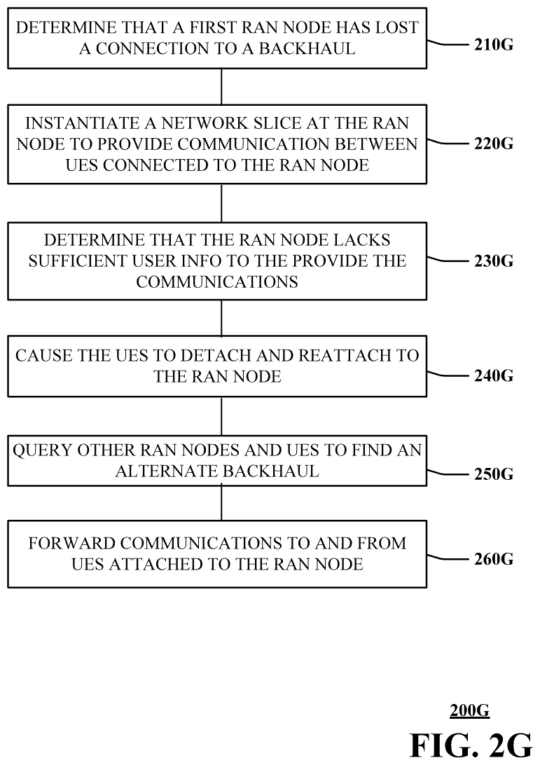

FIG. 2A is a block diagram illustrating an example, non-limiting embodiment of a system functioning within the communication network of FIG. 1 in accordance with various aspects described herein. FIG. 2A shows RAN node 210A and RAN node 220A. RAN nodes 210A and 220A may be any type of RAN node. For example, RAN nodes 210A and 220A may be any combination of eNodeB, gNodeB, nodes with LTE connectivity, nodes with NR connectivity, or any other RAN node capable of providing communications between UEs and a communication network.

In the example scenario 200 shown in FIG. 2A, one or both of RAN nodes 210A and 220A have lost a connection to their backhaul. For example, in some embodiments, RAN node 210A has lost a connection to its backhaul, and RAN node 220A still has a connection to its backhaul. Also for example, in some embodiments, RAN node 220A has lost a connection to its backhaul, and RAN node 210A still has a connection to its backhaul. In a further example, in some embodiments, both RAN nodes 210A and 220A have lost connections to their backhauls.

In some embodiments, even though one or both of RAN nodes 210A and 220A have lost a connection to a backhaul, the RAN nodes 210A and 220A may still be able to communicate using a point-to-point link or network interface 212A. For example, whatever infrastructure is necessary to maintain a network interface may still be in place even though a connection to the backhaul is severed. For example, the network interface 212A may utilize connectivity at the edge of a communications network such as communications network 125 (FIG. 1), and the edge servers of the communication network may still be functional and may still be able to provide the network interface 212A when the backhaul is severed. Also for example, a point-to-point link such as a microwave link may be available between RAN node 210A and RAN node 220A. In a further example, a point-to-point link 212A may be provided by an intermediary device that is connected to both RAN node 210A and RAN node 220A. Examples of intermediary devices, such as UEs with dual connectivity, are described further below.

In some embodiments, a RAN node that has lost connectivity to a backhaul may create a local slice, referred to herein as a “disaster slice.” For example, RAN node 210A may create (or instantiate) disaster slice 214A, and RAN node 220A may create (or instantiate) disaster slice 224A. Disaster slices may be instantiated at RAN nodes or at other nodes reachable by the RAN nodes. For example, disaster slice 214A may be instantiated at RAN node 210A or may be instantiated in a network element within (or at the edge) of communications network 125 (FIG. 1). Also for example, disaster slices may be instantiated within (or as) virtual machines, virtual network elements, containers, or the like.

The instantiation of disaster slices is not limited to disaster scenarios. For example, a disaster slice may be instantiated as a result of a fiber cut, a power outage, or any other event that results in a scenario in which a local disaster slice may prove beneficial (e.g., loss of backhaul connectivity).

In some embodiments, a disaster slice includes functionality capable of providing connectivity between UEs connected to a RAN node. For example, disaster slice 214A may provide functionality to provide communications between UEs connected to RAN node 210A. Further, in some embodiments, a disaster slice includes functionality capable of providing connectivity between UEs connected to two different RAN nodes. For example, disaster slices 212A and 214A may provide functionality to provide communications between a UE connected to RAN node 210A, and a UE connected to RAN node 220A.

A disaster slice may include data repositories, network elements, and any other functions to support UE communication without access to a network core. Accordingly, a disaster slice may emulate a network core or a portion of a network core. In some embodiments, a disaster slice instantiates the minimum number of network elements needed to emulate that portion of a network core that supports texting and calling between UEs. In other embodiments, a disaster slice instantiates more than the minimum necessary to support texting and calling between UEs. For example, a disaster slice may instantiate network elements (e.g., gateways) that support connectivity to data sources (e.g., media streaming resources) outside of the network core.

Disaster slice 214A includes protocol handling element 232A, user management element 234A, alternate path discovery element 236A, and traffic routing element 238A. Protocol handling element 232A manages the communications with the attached UEs and may have any number of virtual network elements instantiated within. For example, protocol handling element 232A may handle protocols such as SlAP, GTP, SIP, and RTP, and may include network elements such as MME, AMF, SMF, HSS PGW/UP, and the like. Any number of protocols may be supported, and any number of network elements may be instantiated to support the operations of the disaster slice.

Alternate path discovery element 236A includes functionality to discover alternate backhaul connections that are reachable by the disaster slice. For example, alternate path discovery element 236 may query other RAN nodes to determine if those RAN nodes have alternate backhaul connections or may query attached UEs to determine if the UEs have connections that may be utilized as alternate backhaul connections.

Traffic routing element 238A routes traffic to and from UEs attached to the RAN node. For example, traffic routing element 238A may route data (e.g., texts, calls, etc.) between two UEs attached to the RAN node at which the disaster slice is instantiated, or traffic routing element 238A may route data between two UEs attached to different RAN nodes.

User management element 234A includes sufficient information regarding the UEs (referred to herein as “user information”) to provide traffic routing element 238A the ability to support communication between the UEs. For example, user management element 234A may include encryption/decryption keys, IP addresses, phone numbers, and any other information useful to determine how to route data to, and communicate with, UEs attached to the RAN node (and in some embodiments, UEs attached to other RAN nodes).

The user information is gathered and/or maintained by the disaster slice in various ways. For example, in some embodiments, the user information is maintained by the RAN node, and when the disaster slice is instantiated, the user information is transferred from the RAN node into the disaster slice. Also for example, in some embodiments, the user information is gathered at the time of the instantiation of the disaster slice. In some embodiments, some of the user information may be available from the UE itself, and some of the information may be available from the communications network core (e.g., encryption keys for the air interface to the UE). In these embodiments, the RAN node may maintain information that may not be available when the connection to the network core is lost (information that is only available from the core) and may gather any remaining information when the disaster slice is instantiated. Various embodiments use various combinations of a RAN node maintaining user information, a RAN node periodically collecting user information from the core and/or the UE, and/or gathering user information during instantiation of the disaster slice.

In some embodiments, when a backhaul connection is severed, and/or when a disaster slice is instantiated, a RAN node may cause all of the UEs attached to the RAN node to detach from the RAN node, and then have the UEs request reattachment to the RAN node. During the reattachment, the RAN node may modify some or all of the connection parameters. For example, the RAN node may advertise an access point name (APN) associated with an unencrypted air interface. This may reduce the amount of user information (e.g., encryption keys) needed to support UE communications by the disaster slice and may reduce the maintenance of user information by the RAN node prior to the disaster slice being instantiated. Also in some embodiments, when a backhaul connection is severed, and/or when a disaster slice is instantiated, a RAN node may cause one or more of the UEs attached to the RAN node to move to a different RAN node. In some embodiments, UEs may detach from the RAN node, and then have the UEs request reattachment to the different RAN node. UEs may be moved from one RAN node to a different RAN node for many different reasons. For example, the different RAN node may be able to provide more connectivity to the UEs, or the different RAN node may have connectivity to a specific UE or class of UEs, such as law enforcement or other first responders.

FIG. 2B is a block diagram illustrating an example, non-limiting embodiment of RAN nodes communicating with UEs in accordance with various aspects described herein. In the example of FIG. 2B, UEs 210B and 220B are connected to RAN node 210A. UE 210B is connected to RAN node 210A over air interface 212B, and UE 220B is connected to RAN node 210A over air interface 222B. Similarly, UEs 230B, 240B, and 250B are connected to RAN node 220A. UE 230B is connected to RAN node 220A over air interface 232B, UE 240B is connected to RAN node 220A over air interface 242B, and UE 250B is connected to RAN node 220A over air interface 252B.

When RAN node 210A instantiates a disaster slice, RAN node 210A provides a communication path between UEs 210B and 220B. User information 202B is an example of user information in a disaster slice, such as user information in user management element 234A (FIG. 2A). The disaster slice (not shown in FIG. 2B) and the user information 202B emulates enough functionality of the network core to provide communications between UEs attached to RAN node 210A (UEs 210B and 220B in this example). In operation, a UE such as UE 210B may initiate a voice call or text message to another UE using existing procedures. When a disaster slice has been instantiated, the RAN node intercepts the voice call or text message signaling rather than passing it to the network core. In the example embodiments of FIG. 2B, the disaster slice determines if the destination UE is connected to the same RAN node, and if so, the call or text message is forwarded. If the destination UE is not connected to the same RAN node, the call or text message is discarded. As an example, if UE 210B initiates a text message to UE 220B, the disaster slice at RAN node forwards the text message to UE 220B, but if UE 210B initiates a text message to UE 230B, the text message is discarded.

Similar to the operation of RAN node 210A instantiating a disaster slice, when RAN node 220A instantiates a disaster slice, RAN node 220A provides a communication path between the UEs attached to RAN node 220A (UEs 230B, 240B, and 250B in this example). User information 204B is an example of user information in a disaster slice instantiated at or near RAN node 220A.

In the example of FIG. 2B, RAN nodes 210A and 220A do not communicate using a point-to-point link or other interface. The result is that communications between UEs is limited to UEs that are attached to the same RAN node. In the example embodiments represented by FIG. 2B, UEs 210B and 220B can communicate with each other through RAN node 210A which has instantiated a disaster slice with user info 202B, and UEs 230B, 240B, and 250B can communicate with each other through RAN node 220A which has instantiated a disaster slice with user info 204B.

FIG. 2C is a block diagram illustrating an example, non-limiting embodiment of RAN nodes communicating with each other and communicating with UEs in accordance with various aspects described herein. In the example embodiments represented by FIG. 2C, RAN nodes 210A and 220A communicate using link 212C. Link 212C may be any type of communications link, including a point-to-point link, an Xn interface, and X2 interface, or a link through any other device capable of communicating with both RAN nodes 210A and 220A and serving as a bridge between the two.

In some embodiments, when disaster slices are instantiated and a link between RAN nodes is available, one or more RAN nodes may share user information with another RAN node. In the example of FIG. 2C, RAN node 210A shares user information 202B with RAN node 220A, which creates a copy shown as user information 202C. Also in some embodiments, RAN node 220A may share user information 204B with RAN node 210A (not shown in FIG. 2C).

Communications link 212C between RAN nodes 210A and 220A, and the sharing of user information between disaster slices at the two RAN nodes facilitates communications between UEs attached to the different RAN nodes. For example, if UE 210B initiates a voice call or text message to UE 250B, the disaster slice at RAN node 210A, having knowledge of the location of UE 250B, may forward the voice call or text message across communications link 212C to RAN node 220A, whose disaster slice then forwards the voice call or text message to the destination UE 250B. This overall logical communications link is shown at 220C.

In some embodiments, the link(s) between the RAN nodes may provide significant connectivity in the case of a severed backhaul. For example, if a large number of RAN nodes are reachable by point-to-point links or by a network interface, then when the RAN nodes instantiate disaster slices and share user information, much of the functionality of the core network may be restored (or emulated) using disaster slices and communications links between RAN nodes.

FIGS. 2D-2F are block diagrams illustrating example, non-limiting embodiments of RAN nodes making use of connection(s) to alternate backhaul(s) in accordance with various aspects described herein.

FIG. 2D shows RAN node 210A having a disaster slice that includes user information 202B. In the example of FIG. 2D, RAN node 210A has attached UEs 210B, 220D, and 210D. UE 210B is attached to RAN node 210A as described above with reference to previous figures. UE 220D is attached to RAN node 210A and communicates over link 222D, and UE 210D is attached to RAN node 210A and communicates using link 212D.

UEs 220D and 210D are examples of UEs having multi radio access technology, referred to herein as “multi-RAT” UEs. For example, UE 220D has a radio access technology to communicate with RAN node 210A, and also has a radio access technology to communicate with a Wi-Fi system shown at 224D. Also for example, UE 210D has a radio access technology to communicate with RAN node 210A and also has a radio access technology to communicate with a satellite system at 214D. In some embodiments, UE 220D includes both a Wi-Fi radio and a cellular radio, and UE 210D includes a satellite radio and a cellular radio. Any number of radio access technologies may be included in the various UEs shown in FIG. 2D.

In some embodiments, RAN node 210A may communicate with UEs to discover whether a UE has multi-RAT capabilities. For example, upon instantiating a disaster slice (or before instantiating a disaster slice), RAN node 210A may query UEs 210B, 220D, and 210D to determine whether any or all of the UEs have multi-RAT technology. In some embodiments, the query may be performed by the alternate path discovery element 236A of the disaster slice instantiated at RAN node 210A as shown in FIG. 2A. Upon determining that one or more UEs has a multi-RAT capability, user information 202B may be updated to identify the UE with multi-RAT technology and the type of multi-RAT technology. User information 202B may also be updated to identify whether the UE having multi-RAT technology is capable of using that multi-RAT technology as an alternate backhaul. For example, UE 220D may be capable of utilizing Wi-Fi connection 224D as an alternate backhaul, and UE 210D may be capable of using satellite connection 214D as an alternate backhaul.

In operation, if UE 210B initiates a communication to a destination that is not included in FIG. 2D but reachable via one of the alternate backhauls, the disaster slice instantiated at RAN node 210A may route the communication to either UE 220D for use of the backhaul implemented at Wi-Fi 224D or may route the communication to UE 210D for use of the alternate backhaul implemented at satellite radio 214D. In embodiments represented by FIG. 2D, UE 220D and UE 210D may be utilized as routers by the disaster slice instantiated at RAN node 210A. For example, UE 220D may route communications originating from UE 210B from the communication link 222D to the communications link 226D and may route communications destined for UE 210B from the communications link 226D to the communications link 222D. Similarly, UE 210D may act as a router by routing communications between communications links 212D and 216D.

In some embodiments, software is installed on one of the multi-RAT UEs to perform the router functions. For example, a software application may be installed on UE 220D to route communications between RAN node 210A and Wi-Fi radio 224D. In some embodiments, the router application installed on UE 220D may be preinstalled on the device by the network communications operator that operates RAN node 210A and the disaster slice instantiated on RAN node 210A. The router software installed on UE 220D may not be visible or accessible by a user of UE 220D. For example, the routing of communications for the purposes of accessing Wi-Fi radio 224D as an alternate backhaul may occur in the background without the knowledge of the user of UE 220D. In other embodiments, a user of UE 220D may be prompted to gain permission for the use of UE 220D and Wi-Fi radio 224D as an alternate backhaul.

FIG. 2E illustrates a system similar to FIG. 2C, with the exception that RAN node 220E includes an alternate backhaul connection. In the example of FIG. 2E, the alternate backhaul connection is implemented by satellite radio 230E coupled to (or part of) RAN node 220E by communications link 222E. In operation, the disaster slice instantiated at RAN node 210A may query other RAN nodes such as RAN node 220E to determine if the other RAN nodes have access to an alternate backhaul.

Upon discovering that RAN node 220E has access to an alternate backhaul implemented by satellite radio 230E, RAN node 210A may route communications from UEs attached to RAN node 210A to RAN node 220E for use of the alternate backhaul implemented by satellite radio 230E.

In some embodiments, RAN node 220E represents a fixed base station that includes satellite radio 230E capable of implementing an alternate backhaul. In other embodiments, RAN node 230E represents a temporary base station (e.g., a cell on wheels, or “COW”) that is deployed as a result of a severed backhaul and disaster slices being instantiated on various RAN nodes.

In some embodiments, multiple RAN nodes connect to one or more other RAN nodes having alternate backhaul connections to create a mesh network between RAN nodes which can be used to enable connectivity for many UEs in a local region. The mesh network may be based on any combination of types of communications links between RAN nodes, including point-to-point wireless links and/or network interfaces between the various RAN nodes.

FIG. 2F shows a system similar to the system shown in FIG. 2E, with the exception that UE 210F is providing a communications link between RAN node 210A and RAN node 220E. As shown in FIG. 2F, UE 210F communicates with RAN node 210A using communications link 212F and communicates with RAN node 220E using communications link 214F.

In some embodiments, a RAN node such as RAN node 210A may not have access to a point-to-point link or a network interface or may be too far away from another RAN node such as RAN node 220E to effectively communicate using a point-to-point link. In some embodiments, a RAN node may query UEs that are attached to the RAN node to determine if the UE can provide a communications link to another RAN node. For example, in operation, RAN node 210A may query UE 210F to determine if UE 210F can provide a communication link to RAN node 220E. If UE 210F is able to provide a communications link to RAN node 220E, RAN node 210A may then query RAN node 220E to determine if RAN node 220E has access to an alternate backhaul. In this manner, a UE may provide a link between RAN nodes which allows other UEs to gain access to an alternate backhaul.

In some embodiments, UE 210F may have multi-RAT capability, or dual connectivity (DC) capabilities such as new radio dual connectivity (NR-DC) or evolved non-standalone dual connectivity (EN DC), which allows UE 210F to communicate with two RAN nodes simultaneously.

FIG. 2G depicts illustrative embodiments of methods in accordance with various aspects described herein. At 210G of method 200G, a first RAN node determines that it has lost a connection to a backhaul. In some embodiments, this may be the result of a natural disaster, a fiber cut, a loss of power of one or more network elements in a communications network, or the like. In some embodiments, a RAN node may determine on its own that it has lost a backhaul connection (e.g., by determining that buffers are filling and communications are not being reliably sent and received). In other embodiments, a RAN node may determine that it has lost a backhaul connection with the aid of other devices. For example, a RAN node may query other devices and find an alternate backhaul connection as described above, and then receive a notification from a communications network informing the RAN node that its backhaul has been severed. In some embodiments, a preconfigured time interval may be configured, such that a RAN node may assume that it has a severed backhaul during that time. For example, if a natural disaster can be predicted (e.g., an approaching hurricane), a time interval for an expected backhaul outage may be configured at the RAN node. If during the expected time period of the natural disaster, the RAN node experiences communications difficulties, it may assume that its backhaul has been severed. In still further embodiments, a RAN node may discover that its backhaul is severed by communicating with UEs that are in coverage areas of multiple RAN nodes. A UE may be able to provide information to the RAN node regarding other backhaul connections, thereby aiding the RAN node in its determination as to whether its own backhaul has been severed.

At 220F, a network slice is instantiated at the RAN node to provide communication between UEs connected to the RAN node. In some embodiments, the network slice represents what is referred to herein as a disaster slice, which may include the minimum amount of network elements necessary to complete voice calls and text messages between UEs that are connected to the RAN node. In other embodiments, an entire network slice may be instantiated at the RAN node to provide all functionality that would otherwise be provided by a complete network core.

In some embodiments, the network slice is instantiated directly at the RAN node. Further, in some embodiments, the network slice is instantiated at a node close to, but not directly at, the RAN node. For example, a disaster slice may be instantiated at the edge of a network when the RAN node still has connectivity to servers at the edge of the network that may instantiate the disaster slice as a virtual machine.

At 230F, the RAN node may determine whether or not it has sufficient user information or information regarding the attached UEs to provide the communications described herein. If the RAN node has the sufficient information, then the RAN node may provide the communications without collecting further user information. In some embodiments, when the RAN node determines that it lacks sufficient information to provide the communications, it may gather the necessary user information. In some embodiments, the RAN node may determine that it lacks the sufficient information, and also lacks the ability to gather that sufficient information.

At 240F, the RAN node may cause the UEs to detach and reattach to the RAN node. In some embodiments, this is in response to determining that the RAN node lacks the sufficient information regarding the users or the UEs in order to provide the local communications between the UEs. In some embodiments, after detaching the UEs, the RAN node may advertise a nonencrypted APN (similar to a 911/SOS APN) to get the UEs to reattach without encryption. This may reduce the amount of information necessary to provide the communications between the UEs attached to the RAN node.

At 250F, the RAN node queries other RAN nodes and UEs to find one or more alternate backhauls. For example, the RAN node may communicate with other RAN nodes via point-to-point links or network interfaces (e.g., Xn interface or X2 interface) to determine if an alternate backhaul is reachable using these interfaces. For example, a RAN node may have a satellite link which may be used as an alternate backhaul. Also for example, a multi-RAT UE may be discovered which has access to a Wi-Fi backhaul, or a satellite backhaul, or the like. In some embodiments, the RAN node may query UEs that are attached to the RAN node to determine if any of the UEs can provide a communications link to other RAN nodes. For example, if the RAN node lacks a point-to-point link or network interface to another RAN node, that RAN node may be able to communicate with other RAN nodes using a UE that has multi-RAT capability or dual connectivity capability as described above.

At 260F, the RAN node forwards communications to and from UEs attached to the RAN node. In some embodiments, this corresponds to a disaster slice forwarding communications between UEs that are attached directly to the RAN node. In other embodiments, this corresponds to forwarding communications from UEs attached to the RAN node to other RAN nodes which then forward the communications to the appropriate UE.

While for purposes of simplicity of explanation, the respective processes are shown and described as a series of blocks in FIG. 2G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

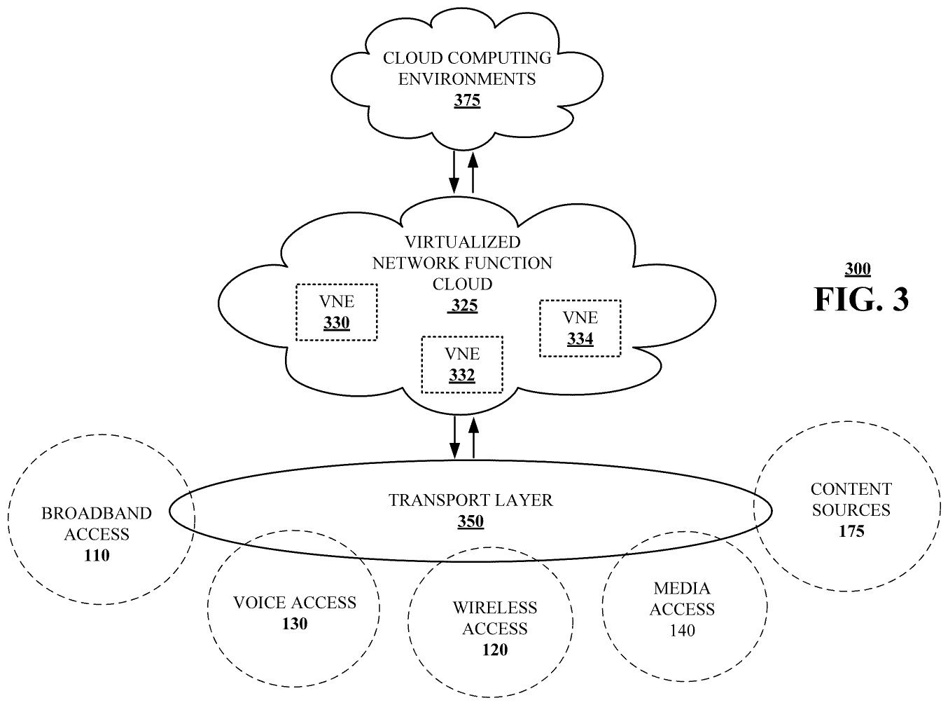

Referring now to FIG. 3, a block diagram 300 is shown illustrating an example, non-limiting embodiment of a virtualized communication network in accordance with various aspects described herein. In particular a virtualized communication network is presented that can be used to implement some or all of the systems, subsystems, and functions described herein. For example, virtualized communication network 300 can facilitate in whole or in part increasing user connectivity during the loss of a backhaul connection.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

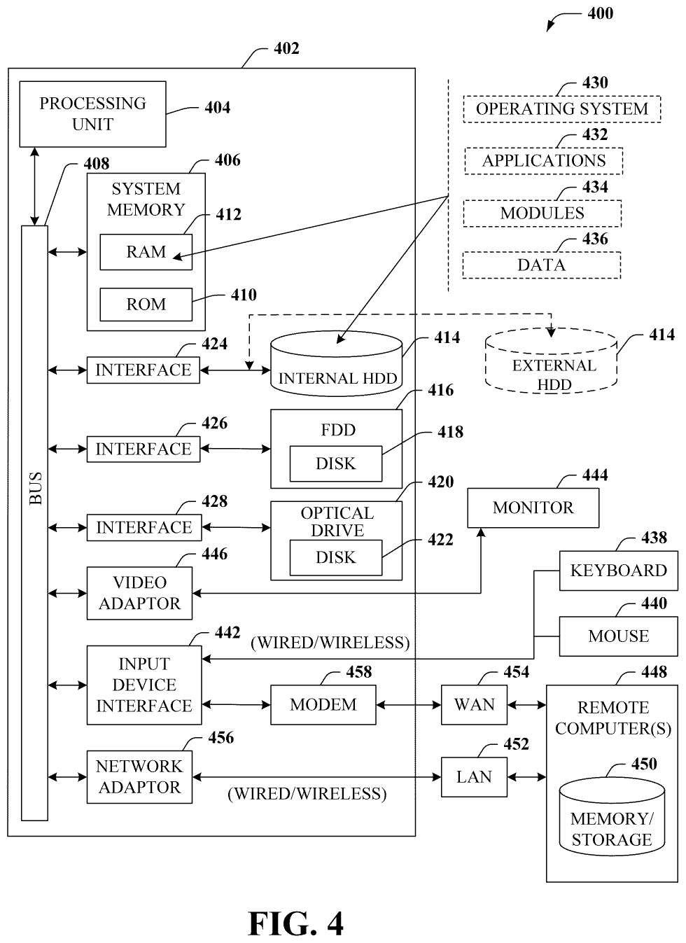

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part increasing user connectivity during the loss of a backhaul connection.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

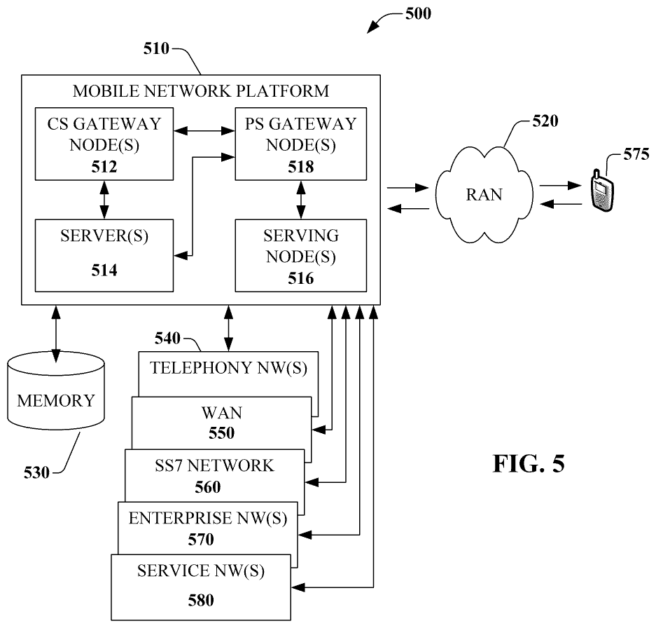

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part increasing user connectivity during the loss of a backhaul connection. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

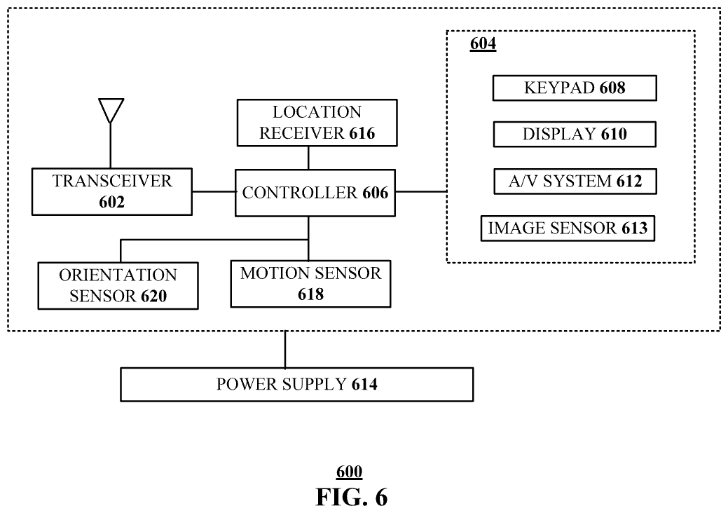

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part increasing user connectivity during the loss of a backhaul connection.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
determining that a first radio access network (RAN) node has lost connection to a first backhaul;
instantiating a network slice at the first RAN node to provide communication between user equipments (UEs) connected to the first RAN node.

2. The device of claim 1, wherein the determining that the first RAN node has lost connection to the first backhaul comprises determining that the first RAN node has lost connection to a core network.

3. The device of claim 1, wherein the instantiating the network slice comprises determining that the first RAN node maintains sufficient information regarding the UEs to provide the communication between the UEs.

4. The device of claim 1, wherein the instantiating the network slice comprises:
determining that the first RAN node lacks sufficient information regarding the UEs to provide the communication between the UEs;
detaching the UEs from the first RAN node;
reattaching the UEs to the first RAN node; and
collecting the sufficient information regarding the UEs to provide the communication between the UEs.

5. The device of claim 4, wherein the reattaching the UEs to the first RAN node comprises reattaching the UEs without encryption.

6. The device of claim 1, wherein the operations further comprise:
the first RAN node communicating with a second RAN node;
sharing information regarding the UEs with the second RAN node; and
providing communication between at least one of the UEs connected to the first RAN node and at least one other UE connected to the second RAN node.

7. The device of claim 6, wherein the first RAN node communicates with the second RAN node over a network interface to provide the communication between the at least one of the UEs connected to the first RAN node and the at least one other UE connected to the second RAN node.

8. The device of claim 6, wherein the first RAN node communicates with the second RAN node through a wireless device connected to both the first RAN node and the second RAN node using cellular dual connectivity.

9. The device of claim 1, wherein the operations further comprise:
the first RAN node communicating with a second RAN node to determine if the second RAN node has a connection to a second backhaul; and
providing a communication path between at least one of the UEs and the connection to the second backhaul over a network interface between the first RAN node and the second RAN node.

10. The device of claim 9, wherein the second backhaul comprises a satellite connection at the second RAN node.

11. The device of claim 1, wherein the operations further comprise:
determining that a first UE of the UEs has a multi radio access technology (RAT) capability;
determining that the multi-RAT capability supports a connection to a second backhaul; and
using the connection to the second backhaul to provide communications abilities to ones of the UEs other than the first UE.

12. A non-transitory machine-readable medium, comprising executable instructions that, when executed by a processing system including a processor, facilitate performance of operations, the operations comprising:
determining that a first RAN node has lost a connection to a first backhaul;
communicating, by the first RAN node, with other RAN nodes to find a connection to a second backhaul;
responsive to the communicating, determining that a second RAN node has the connection to the second backhaul; and
providing a communication path for at least one user equipment (UE) attached to the first RAN node to the second RAN node for use of the connection to the second backhaul.

13. The non-transitory machine-readable medium of claim 12, wherein the providing the communication path comprises communicating, by the first RAN node, with the second RAN node over a network interface between the first RAN node and the second RAN node.

14. The non-transitory machine-readable medium of claim 12, wherein the providing the communication path comprises communicating, by the first RAN node, with the second RAN node through a device connected to both the first RAN node and the second RAN node using cellular dual connectivity.

15. A method, comprising:
collecting, at a first radio access network (RAN) node, by a processing system including a processor, information regarding a plurality of UEs connected to the first RAN node;
instantiating, by the processing system, in response to the first RAN node losing a connection to a communication network core, a disaster slice at the first RAN node, wherein the disaster slice provides communications among the plurality of UEs connected to the first RAN node using the information regarding the plurality of UEs connected to the first RAN node; and
communicating, by the processing system, with other wireless devices to determine if a connection to an alternate backhaul is available.

16. The method of claim 15, wherein the communicating with other wireless devices comprises communicating with the plurality of UEs to determine if any of the plurality are multi radio access technology (RAT) devices capable of providing the connection to the alternate backhaul.

17. The method of claim 15, wherein the communicating with other wireless devices comprises communicating with RAN nodes other than the first RAN node.

18. The method of claim 17, wherein the communicating other RAN nodes comprises communicating over a network interface.

19. The method of claim 15 wherein the instantiating the disaster slice comprises instantiating a subset of core network functions at the first RAN node.

20. The method of claim 15, further comprising sharing, by the processing system, the information regarding the plurality of UEs with a second RAN node to provide communications between one of the plurality of UEs attached to the first RAN node and at least one UE attached to the second RAN node, wherein the communications between the one of the plurality of UEs attached to the first RAN node and at least one UE attached to the second RAN node uses a network interface between the first RAN node and the second RAN node.
